(19) United States
(12) Patent Application Publication
(10) Pub. No.: US 2012/0316853 A1
(43) Pub. Date: Dec. 13, 2012

(54) COMPUTER BASED METHODS FOR SIMULATING ROTATIONAL DRAG FORCE

(76) Inventors: Michael Timothy Looney, Blue Ash, OH (US); Lei Li, Mason, OH (US); Stephen Joseph Lange, Cincinnati, OH (US); Mark David Whaley, Liberty Township, OH (US)

(21) Appl. No.: 13/171,824

(22) Filed: Jun. 29, 2011

Related U.S. Application Data
(60) Provisional application No. 61/495,566, filed on Jun. 10, 2011.

(51) Int. Cl. G06G 7/64

(52) U.S. Cl. 703/7

(57) ABSTRACT

Computer based methods for simulating rotational drag forces experienced by rotating objects.

### CROSS-REFERENCE TO RELATED APPLICATION

This application claims priority to U.S. provisional application 61/495,566, filed Jun. 10, 2011, which is hereby incorporated by reference.

### FIELD

In general, embodiments of the present disclosure relate to computer based models of rotating objects. In particular, embodiments of the present disclosure relate to computer based methods for simulating rotational drag forces experienced by rotating objects.

### BACKGROUND

Many machines use rotating machine elements, such as rollers. For example, machines use rollers for web handling processes. During a web handling process, a web of material moves along a web path and contacts one or more rollers. As the web moves over a roller, the roller rotates around an axis of rotation. It can be difficult to predict the physical behavior of the web and the roller as they interact within a machine. As a result, it can be difficult to predict whether or not a machine can successfully be used to handle a web of material.

### SUMMARY

However, embodiments of the present disclosure can at least assist in predicting whether or not a machine can successfully be used to handle a web of material. The present disclosure includes methods of simulating the physical behavior of a web and one or more rollers as they interact within a machine. In particular, the present disclosure includes computer based methods for simulating rotational drag forces experienced by rollers. As a result, machines and webs can be evaluated and modified as computer based models before they are tested as real world things.

### BRIEF DESCRIPTION OF THE DRAWINGS

FIG. 1 is a diagram that illustrates a perspective view of part of a first exemplary real world machine for handling a web.

FIG. 2 is a diagram that illustrates a perspective view of part of a second exemplary real world machine for handling a web.

FIG. 3A is a first graph of exemplary rotational drag force versus angular velocity for a rotating bearing from the machine of FIG. 1.

FIG. 3B is a second graph of exemplary rotational drag force versus a rotational drag factor.

FIG. 3C is a third graph of exemplary rotational drag force versus a rotational drag factor.

FIG. 3D is a fourth graph of exemplary rotational drag force versus a rotational drag factor.

FIG. 4A is a diagram that illustrates a perspective view of a computer based model of the machine and the web of FIG. 1.

FIG. 4B is a diagram that illustrates a perspective view of a computer based model of the machine and the web of FIG. 2.

FIG. 5 is a diagram that illustrates a side view of the geometry of a portion of the computer based model of FIG. 4A.

FIG. 6 is a flowchart that illustrates a method for simulating with the computer based models of FIGS. 4A and 4B.

### DETAILED DESCRIPTION

Embodiments of the present disclosure can at least assist in predicting whether or not a machine can successfully be used to handle a web of material. The present disclosure includes methods of simulating the physical behavior of a web and one or more rollers as they interact within a machine. In particular, the present disclosure includes computer based methods for simulating rotational drag forces experienced by rollers. As a result, machines and webs can be evaluated and modified as computer based models before they are tested as real world things.

Computer aided engineering (CAE) is a broad area of applied science in which technologists use software to develop computer based models of real world things. The models can be used to provide various information about the physical behavior of those real world things, under certain conditions and/or over particular periods of time. With CAE, the interactions of the computer based models are referred to as simulations. Sometimes the real world things are referred to as a problem and the computer based model is referred to as a solution.

There are several major categories of CAE. Finite element analysis (FEA) is a major category of CAE, in which models of mechanical components and/or assemblies are used to predict stress, strain, deformation, movement, and other mechanical behaviors. There are also a number of other categories of CAE. Some aspects of CAE can also relate to various Computer Aided technologies, sometimes collectively referred to as CAx. CAx includes a number of technologies, such as Computer Aided Design (CAD), Computer Aided Manufacturing (CAM), and Knowledge Based Engineering (KBE).

Commercially available software can be used to conduct CAE. ABAQUS, from SIMULIA in Providence, R.I., USA and LSDYNA from Livermore Software Technology Corp. in Livermore, Calif., USA are examples of commercially available FEA software. CAE software can be run on various computer hardware, such as a personal computer, a minicomputer, a cluster of computers, a mainframe, a supercomputer, or any other kind of machine on which program instructions can execute to perform CAE.

CAE software can be applied to a number of real world things, including machines and materials. For example, CAE can be used to represent a machine handling a web, as described below.

Any and all of the methods of the present disclosure that use computer based models can be represented as program instructions for causing a device to perform a method, and such instructions can be stored on any form of computer readable medium known in the art. Such instructions can also be stored and used as part of a computer-based system.

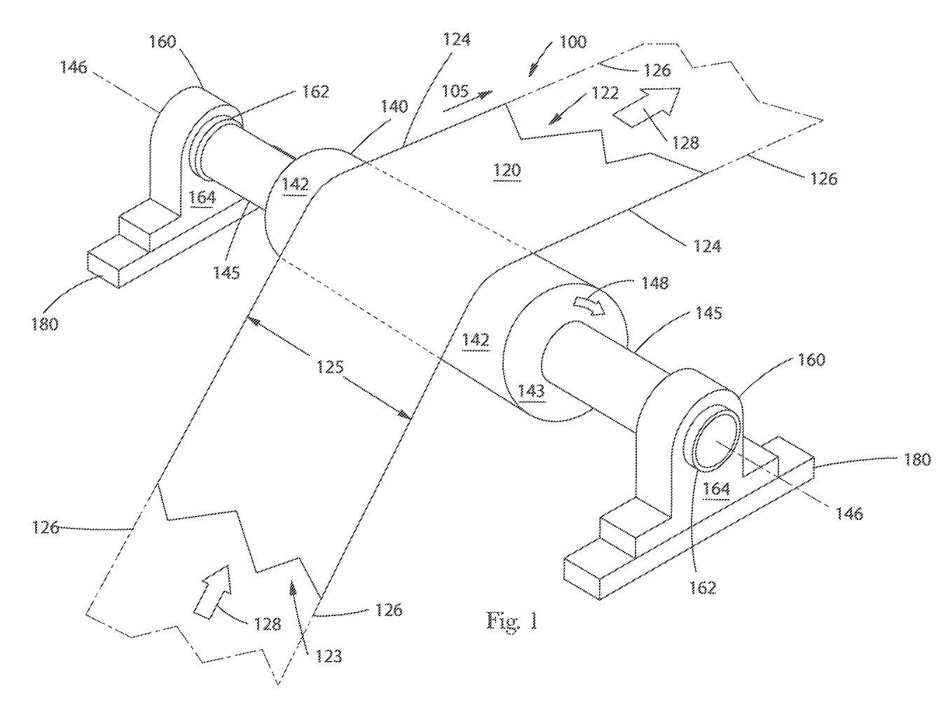

FIG. 1 is a diagram that illustrates a perspective view of part of a first exemplary real world machine 100 for handling a web 120. The machine 100 has an idler 140 inserted in mounted bearings 160 that are attached to support surfaces 180. The machine 100 has a machine direction 105, which indicates the overall direction that the web moves through the machine 100.

The web 120 is a single continuous sheet of relatively thin, flat, flexible material. The web 120 has a leading edge 122 and a trailing edge 123, shown as broken to indicate that the web 120 is a portion of a continuous web. The web 120 also has two parallel sides 124, which define a uniform overall width 125.

There is one idler 140, which is considered to be a rotatable object. The idler 140 has a cylindrical roll face 142, and two circular roll ends 143. A cylindrical idler shaft 145 protrudes from each roll end 143. Each of the roll ends 143 and each of the idler shafts 145 is radially centered on an axis of rotation 146. Each idler shaft 145 is held by a rotating bearing 162.

There are two mounted bearings 160. Each of the mounted bearings 160 includes a rotating bearing 162 that is mounted in a base mount 164. Each rotating bearing 162 holds the end of one of the idler shafts 145. Each rotating bearing 162 has an inner contact surface that is connected to a corresponding idler shaft 145. The connection prevents the idler shaft 145 from sliding or rotating with respect to the inner contact surface of the rotating bearing 162. The inner contact surface of each rotating bearing 162 can rotate around the axis 146 within its base mount 164. However, in various embodiments, the machine 100 may only include one mounted bearing 160, such that the idler 140 is cantilevered, held at only one end.

There are two support surfaces 180. Each base mount 164 is rigidly attached to a support surface 180. In the embodiment of FIG. 1, each support surface 180 is fixed in position. The support surfaces 180 can be attached to one or more other structures (not shown). In various alternate embodiments, either or both of the support surfaces can move with respect to a larger physical context. For example, the support surfaces can move as part of an apparatus that can move with defined motion within the machine.

The web 120 moves 128 forward along a defined web path 126. Throughout the present disclosure, for a web, forward movement refers to movement downstream (with the machine direction 105), while backward movement refers to movement upstream (against from the machine direction 105). The web path 126 is defined, at least in part, by its contact with surfaces within the machine 100. These contact surfaces include constraints upstream from the trailing edge 123, the roll face 142 of the idler 140, and constraints downstream from the leading edge 122.

While embodiments of the present disclosure are described with forward movement and rotation, any of the embodiments of the present disclosure can also provide for backward movement and rotation, as well as combinations of forward and backward movement and/or forward and backward rotation, as will be understood by one of skill in the art.

The idler 140 is an undriven roller; that is, a roller that is rotated by contact with the web 120 and not by the machine 100. As the web 120 contacts the idler 140, and the web 120 moves 128, the idler 140 rotates 148 forward around the axis 146. Throughout the present disclosure, for a roller, such as an idler, forward rotation refers to rotation that would move a web downstream, while backward rotation refers to rotation that would move a web upstream. As the idler 140 rotates 148 forward, the inner contact surface of each rotating bearing 162 also rotates forward within its base mount 164. Since the idler shafts 145 are connected to the inner contact surfaces of the rotating bearings 162, the inner contact surfaces and the shafts 145 rotate at the same particular angular velocity. Since the base mounts 164 are attached to the support surface 180, the base mounts 164 do not move. Since the support surfaces 180 are fixed in position, the support surfaces 180 also do not move.

The embodiment of FIG. 1 can be varied in many ways, as will be understood by one of skill in the art. The web 120 can be any kind of web, in any configuration known in the art, including any configuration described herein. The web can be a continuous piece of material or the web can be a closed loop of material. The web can be any kind of sheet, ribbon, belt, rope, string, strand, or any other kind of web, or a composite of one or more of any of these, joined together in any way. The web can be of any size and shape. The web can be of any length, any width, and any thickness, any of which can be uniform or variable over part, parts, or all of the web. The web can be made of any material. For example, the web can be made of foil, metal, paper, textile, nonwoven, plastic, film, wire, etc. Part, parts, or all of the web can also be made of multiple materials, joined together in any way. For example, the web can be a laminate with a film layer and a nonwoven layer. The surface of the web can be continuous or discontinuous, over part, parts, or all of the web. For example, a web with a discontinuous surface can be a perforated web with holes through its thickness. Part, parts, or all of either or both surfaces of the web can be smooth, or be textured, or can have recesses, or can have protrusions, or any combination of any of these. Any of the variations described above and any other variations known in the art can be combined in any way, with any embodiment of a machine, in any of the embodiments described herein. In an alternate embodiment of FIG. 1, the web 120 can be replaced with anything that can cause the idler 140 to rotate.

The idler 140 can be any kind of undriven roller, in any configuration known in the art, including any configuration described herein. The idler can be any kind of caster, pulley, sheave, wheel, or any other kind of idler. The idler can be a ball roller, cam roller, conveyor roller, guide roller, track roller, web roller, wheel roller, or any other kind of roller. The idler can be of any size and shape. The idler can be of any width and diameter, either of which can be uniform or variable over part, parts, or all of the idler. The idler can be made of any material. For example, the idler can be made of ceramic, metal, plastic, rubber, etc. Part, parts, or all of the idler can also be made of multiple materials, joined together in any way. For example, the idler can be a metal roller with a rubber coating on its roll face. Part, parts, or all of the idler can be hollow or solid. The outer surfaces of the idler can be continuous or discontinuous, over part, parts, or all of the idler. For example, the idler can have one or more grooves on its outer surface. Part, parts, or all of the outer surfaces of the idler can be smooth, or be textured, or can have holes, or can have recesses, or can have protrusions, or any combination of any of these. Any of the variations described above and any other variations known in the art can be used in any way, with any embodiment of a web, and can be combined in any way, within any embodiment of machine, in any of the embodiments described herein. In an alternate embodiment of FIG. 1, the idler 140 can be replaced with any rotatable object.

Either or both of the bearings 160 can be any number of any kind of rotational bearing, in any configuration known in the art, including any configuration described herein. The rotational bearing can be a flexure bearing, a fluid bearing (using liquid and/or gas), a magnetic bearing, a mechanical bearing, or any other kind of bearing, or any bearing using any combination of any of these approaches. A mechanical rotational bearing can use any kind of lubrication in any way or can use no lubrication. A mechanical rotational bearing can be a ball bearing, a journal bearing, a plain bearing (e.g. a bushing), a roller bearing, a sleeve bearing, or any other kind of mechanical rotational bearing. The rotational bearing can be of any size and shape. The rotational bearing can be configured to mount in any way. The rotational bearing can be made of various materials. For example, the rotational bearing can be made of ceramic, metal, plastic, etc. Any of the variations described above and any other variations known in the art can be used in any way, with any embodiment of a web, and can be combined in any way, within any embodiment of machine, in any of the embodiments described herein. In an alternate embodiment of FIG. 1, either or both of the bearings 160 can be replaced with anything that can exert a rotational drag force on the idler 140.

Either or both of the support surfaces 180 can be any number of any kind of support structure, in any configuration known in the art.

In various alternate embodiments of FIG. 1, the idler can be replaced with any rotatable object, and/or the web can be replaced with anything that can cause the object to rotate, and/or the bearings can be replaced with anything that can exert a rotational drag force on the object. As an exemplary alternate embodiment, the idler 140, the web 120, and the bearings 160 can be replaced with machine elements in a power transmission system. For example, the idler 140 can be replaced with an idler sprocket and the web 120 can be replaced with a chain that can cause the idler sprocket to rotate. As another example, the idler 140 can be replaced with a gear and the web 120 can be replaced with a rack that can cause the gear to rotate. As another example, the idler 140 can be replaced with a rotating object and either or both of the 160 bearings can be replaced with one or more machine elements that can exert a rotational drag force on the rotating object, such as a brake, a clutch, a coupling, a joint, or a transmission.

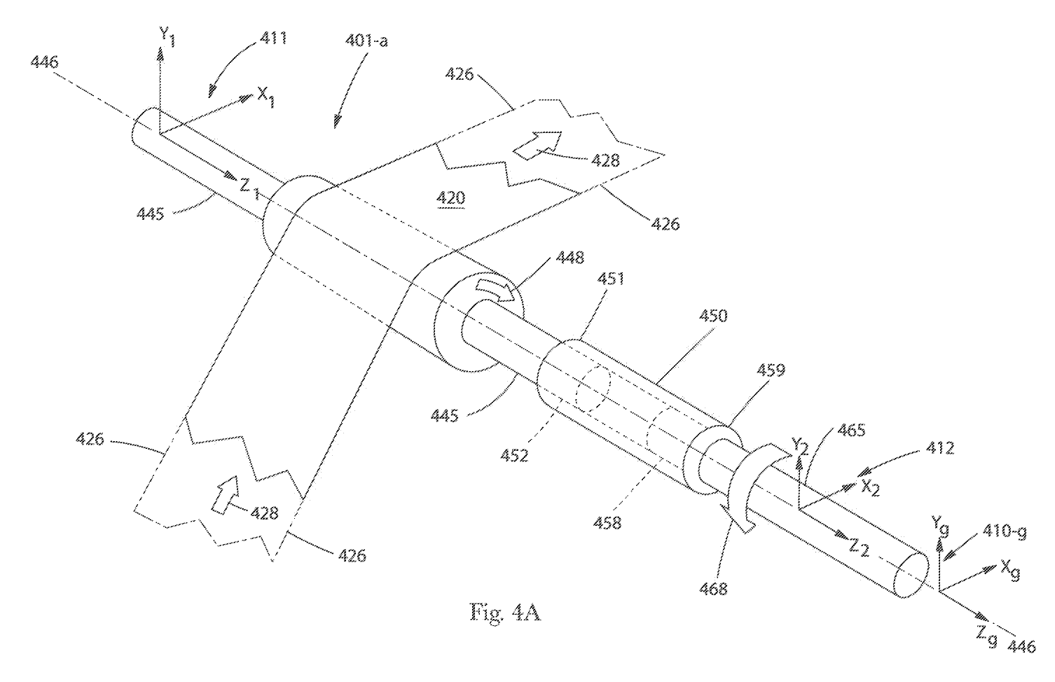

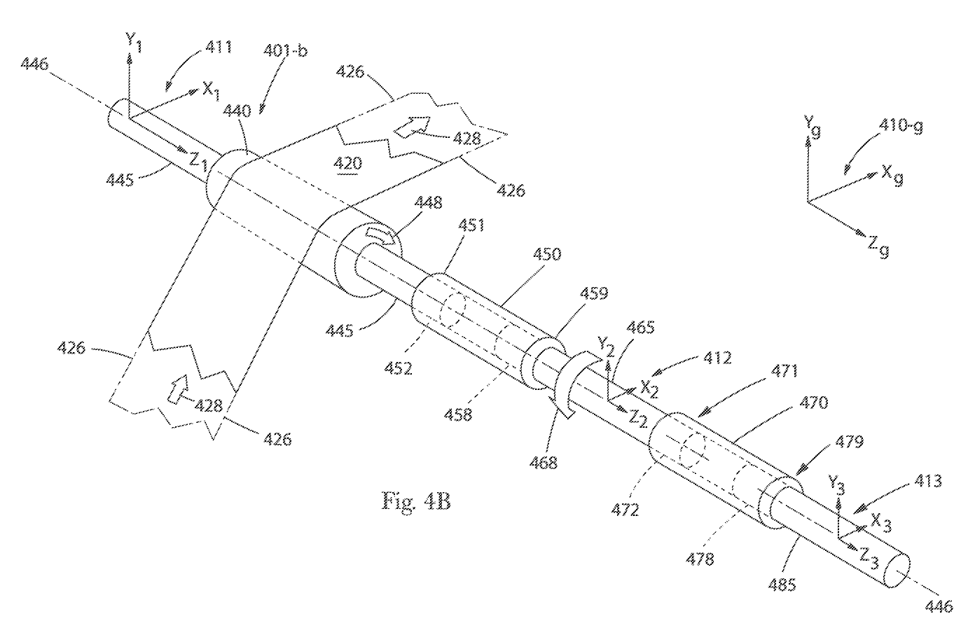

Each of these real world structures in FIG. 1 is subject to real world constraints. While the web 120 can move along the web path 126, the web 120 is constrained to follow the web path 126. As the web 120 contacts the idler 140, there is friction between the web 120 and the roll face 142 of the idler 140. This friction constrains the movement of the web 120 along the web path 126. This friction also constrains the movement of the web 120 and the idler 140 with respect to each other. Since the support surfaces 180 are fixed in position, each of the support surfaces 180 has zero degrees of freedom. Since the base mounts 164 are rigidly attached to the support surfaces 180, each of the base mounts 164 also has zero degrees of freedom. Since the inner contact surface of each rotating bearing 162 can rotate within its base mount 164, each of the rotating bearings 162 has one degree of freedom, which is rotation around the axis 146. There is also friction between the inner contact surface of each rotating bearing 162 and its base mount 164. Since the shafts 145 of the idler 140 are fixed in the rotating bearings 162, the idler 140 also has one degree of freedom, which is rotation 148 around the axis 146. These constraints can be used to represent these real world structures with one or more computer based models of the structures, as described in connection with the embodiments of FIGS. 4A and 4B.

Each of these real world structures is also subject to real world forces, resulting in various reactions. As upstream equipment and downstream equipment pull on the web 120, the web 120 comes under tensions. The tensions strain the web 120 and the pulling moves 128 the web 120 along the web path 126.

As the tensioned web 120 contacts the idler 140, the idler 140 is stressed, strained, and deflected. As the idler 140 contacts the mounted bearings 160, the mounted bearings 160 are also stressed, strained, and deflected. As the mounted bearings 160 contact the support surfaces 180, the support surfaces 180 are also stressed, strained, and deformed in their fixed positions.

Further, as the moving web 120 contacts the roll face 142 of the idler 140, friction imparts a force on the roll face 142. This force, applied at the radius of the idler 140, creates a moment. That moment causes the idler 140 to rotate around the axis 146. Further, as the idler 140 rotates around the axis 146, the connections between the shafts 145 and the inner contact surfaces of the rotating bearings 162 cause the inner contact surfaces of the rotating bearings 162 to rotate around the axis 146.

Notably, internal friction within the mounted bearings 160 causes the inner contact surfaces of the rotating bearings 162 to resist rotation within its base mount 164. This internal friction can be caused by mechanical contact and/or by fluid resistance. Throughout the present disclosure, this resistance to rotation is referred to as rotational drag force. In the present context, rotational drag force is a kind of reaction force, which will oppose any moment that attempts to cause rotation.

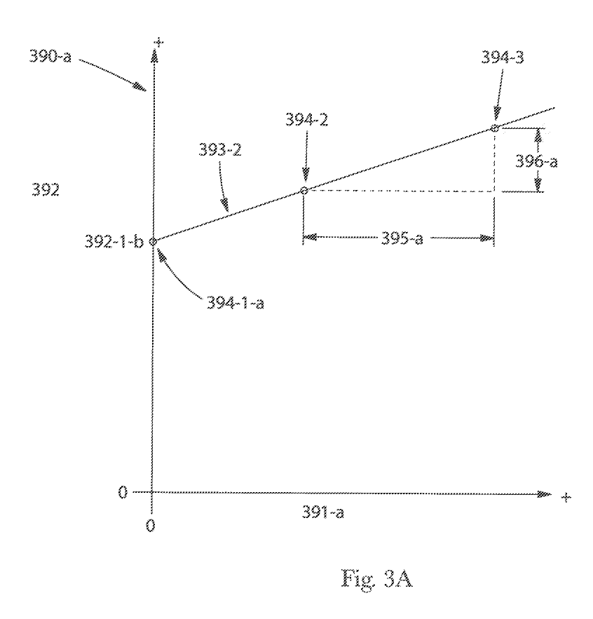

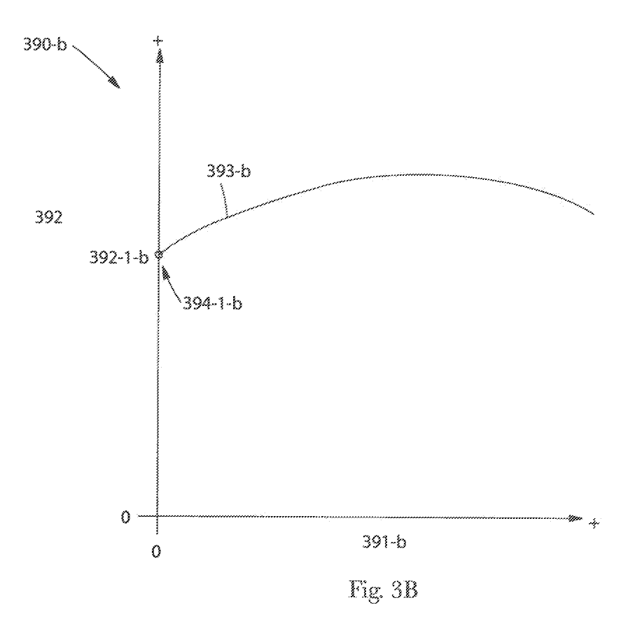

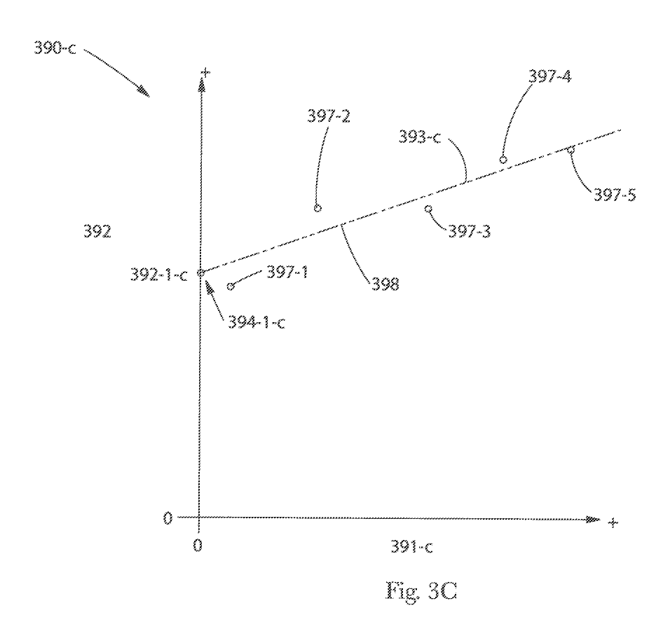

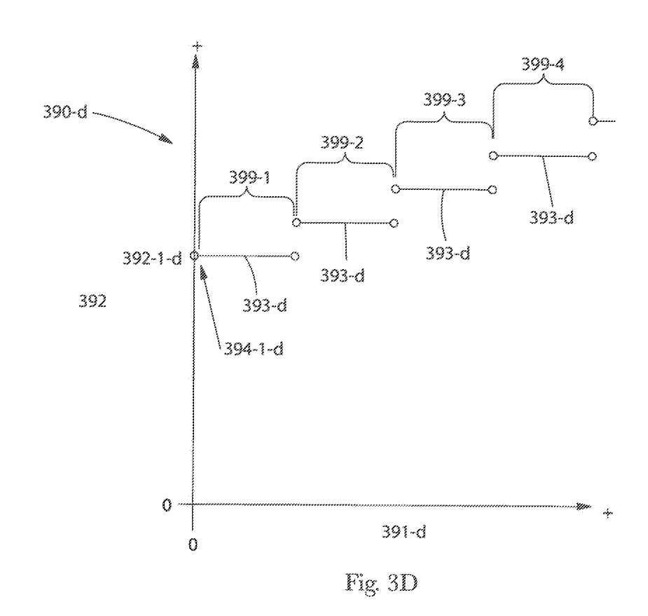

Like any force, rotational drag force has magnitude and direction. The magnitude of a rotational drag force is always less than or equal to the magnitude of the moment that is attempting to cause rotation. The effect of the rotational drag force depends on the relationship between the magnitude of the moment and the static rotational drag force value, as described in connection with the embodiments of FIGS. 3A-3D.

As used herein, the term static rotational drag force refers to the rotational drag force of a rotatable object that is stationary, wherein that force must be overcome by a moment in order to cause the object to rotate. If the moment is less than or equal to a static rotational drag force value, then the rotational drag force is equal to the moment, the sum of the rotational forces is equal to zero and there will be no rotation. If the moment is greater than a static rotational drag force value, then the rotational drag force is less than the moment, the sum of the rotational forces is not equal to zero and there will be rotation.

The direction of a rotational drag force is always opposite to the direction of the moment that is attempting to cause rotation. If the moment is attempting to cause forward rotation, then the rotational drag force will resist the forward rotation. If the moment is attempting to cause backward rotation, then the rotational drag force will resist the backward rotation. And, like any force, rotational drag force acts upon real world structures, such as the real world structures in FIG. 1.

Just as the forces from the web 120 are transmitted to the idler 140 and the mounted bearings 160, the rotational drag forces from the mounted bearings 160 are transmitted to the idler 140 and the web 120. The rotational drag forces are transmitted from the rotating bearings 162 to the idler 140 by their connections. The moment attempts to rotate the idler 140 forward, and the rotational drag forces attempt to resist the forward rotation. In the embodiment of FIG. 1, the rotational drag forces are less than the moment, so the idler 140 moves 148 forward with the web 120. The idler 140 rotates 148 forward around the axis 146 at a particular angular velocity.

The rotational drag forces are also transmitted from the idler 140 to the web 120 by friction. The tensioned web 120 attempts to move forward and the rotational drag forces attempt to resist the forward movement of the web 120. In the embodiment of FIG. 1, the rotational drag forces are less than the pull from downstream, so the web 120 moves 128 forward with the idler 140. The web 120 moves 128 forward along the web path 126 at a particular surface velocity. In the embodiment of FIG. 1, friction between the web 120 and the roll face 142 prevents slipping between the web 120 and the idler 140. However, in various instances, friction between the web 120 and the roll face 142 may not prevent slipping between the web 120 and the idler 140.

The rotational drag forces also affect the tensions in the web 120. Due to the rotational drag forces, the tension in the portion of the web 120 that is immediately upstream from the roller 140 is less than the tension in the portion of the web 120 that is immediately downstream from the roller 140.

So, the rotational drag forces from the mounted bearings 160 affect the physical behaviors of the machine 100 and the web 120 of FIG. 1. These affects are complicated by the fact that real world rotational drag forces can vary with certain rotational drag factors. This variation is described in connection with the embodiments of FIGS. 3A-3D.

The rotatable object of FIG. 1, including any variations and any alternate embodiments, can be represented by one or more computer based models as described in connection with the embodiments of FIGS. 4A and 4B. Each of these models can be used in computer based methods for simulating rotational drag forces experienced by the rotating object, as described herein.

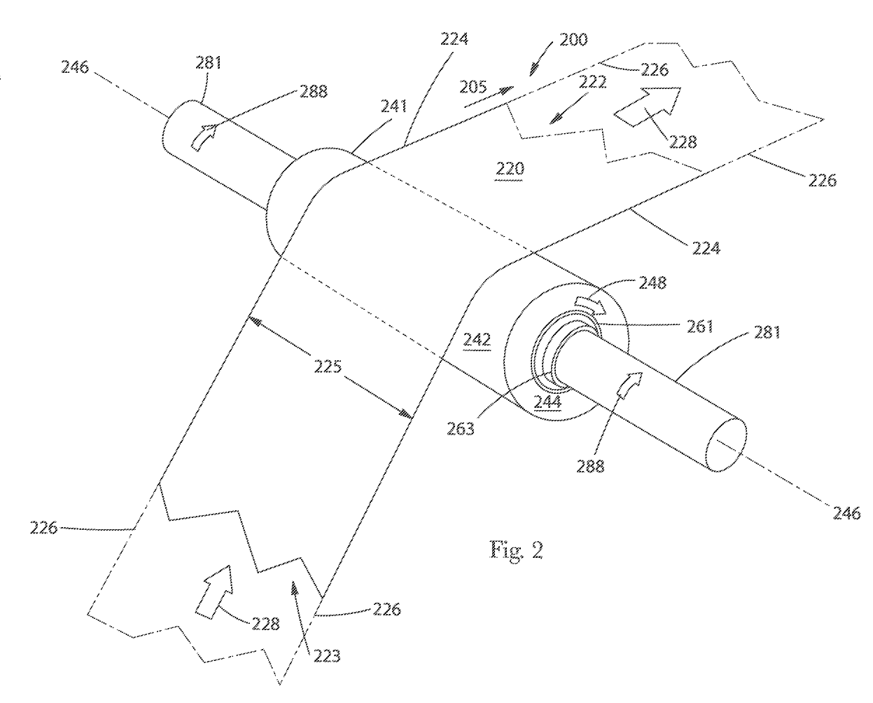

FIG. 2 is a diagram that illustrates a perspective view of part of a second exemplary real world machine 200 for handling a web 220. The machine 200 has a roller 241. Roller bearings 261 are inserted into the roll ends 244 of the roller 241. Support shafts 281 are inserted into the roller bearings 261. The machine 200 has a machine direction 205.

The web 220 of FIG. 2 is the same as the web 120 of FIG. 1, with like-numbered elements configured in the same way. There is one roller 241, which is considered a rotatable object. The roller 241 has a cylindrical roll face 242, and two circular roll ends 244. Each of the roll ends 244 has an opening. Each of the roll ends 244 is radially centered on an axis of rotation 246.

There are two roller bearings 261. Each roll end 244 holds one of the roller bearings 261. Each roller bearing 261 has an outer contact surface that is connected to the opening of its corresponding roll end 244. The connection prevents the roller 241 from sliding or rotating with respect to the outer contact surface of the roller bearing 261. However, in various embodiments, the machine 200 may only include one roller bearing 261, such that the roller 241 is cantilevered, held at only one end.

Each of the roller bearings 261 has a rotating bearing 263. Each of the rotating bearings 263 holds one of the support shafts 281. Each rotating bearing 263 has an inner contact surface that is connected to an end of a corresponding support shaft 281. The connection prevents the support shaft 281 from sliding or rotating with respect to the inner contact surface of the rotating bearing 263. The inner contact surface of each rotating bearing 263 can rotate around the axis 246 within its roller bearing 261.

There are two cylindrical support shafts 281. A support shaft 281 protrudes from each rotating bearing 263. Each of the support shafts 281 is radially centered on the axis 246. Each support shaft 281 can rotate around the axis 246 with the inner contact surface of its rotating bearing 261; however, in the embodiment of FIG. 2, each support shaft 281 is otherwise fixed in position. The support shafts 281 can be attached to one or more other structures (not shown). In various alternate embodiments, either or both of the support shafts can move with respect to a larger physical context. For example, the support shafts can move as part of an apparatus that can move with defined motion within the machine.

The web 220 moves 228 forward along a defined web path 226, which is the same as the web path 126 of FIG. 1. The roller 241 is a driven roller. In particular, the roller 241 is a tendency roller.

A tendency roller is a roller that is driven through one or more bearing connections to rotate at a particular angular velocity. The particular angular velocity is based on the surface speed of the web that contacts the tendency roller. The particular angular velocity is chosen such that the tendency roller rotates at a particular angular velocity. In some instances, the surface speed on its roll face can be based on the surface speed of the web. So long as the driven speed is such that the surface speed on its roll face matches the speed of the web, the tendency roller does not rotate at its bearing connection. If, however, the driven speed is such that the surface speed on its roll face does not match the speed of the web, then the tendency roller can rotate at its bearing connection to allow for the difference.

The web 220 contacts the roller 241 and the web 220 moves 228. The machine 200 drives the support shafts 281 to rotate 288 forward around the axis 246. The roller 241 also rotates 248 forward around the axis 246. The roller 241 rotates 248 at a particular angular velocity and the support shafts 281 rotate 288 at the same particular angular velocity. Since there is no difference between these angular velocities, the inner contact surface of each rotating bearing 263 does not rotate within its roller bearing 261. Since the roller bearings 261 are connected to the roller 241, the outer contact surface of each roller bearing 261 does not rotate with respect to the roller 241.

However, in various instances, the roller 241 may rotate at a particular angular velocity and the support shafts 281 may rotate at a different particular angular velocity. In such instances, each rotating bearing 263 can rotate within its roller bearing 261. If the support shafts 281 rotate faster than the roller 241, then the inner contact surfaces of the rotating bearings 263 rotate forward with respect to the outer contact surfaces of their roller bearings 261, and the outer contact surfaces rotate backward with respect to the inner contact surfaces. If the support shafts 281 rotate slower than the roller 241, then the inner contact surfaces of the rotating bearings 263 rotate backward with respect to the outer contact surfaces of their roller bearings 261, and the outer contact surfaces rotate forward with respect to the inner contact surfaces. In each of these instances, rotational drag forces attempt to resist the relative rotation between the inner contact surfaces and the outer contact surfaces.

The embodiment of FIG. 2 can be varied in many ways, as will be understood by one of skill in the art. The web 220 can be any kind of web, as described herein, or in any configuration known in the art. The roller 241 can be any kind of roller, as described herein, or in any configuration known in the art. Either or both of the bearings 261 can be any number of any kind of bearing, as described herein, or in any configuration known in the art. Either or both of the support shafts 281 can be any number of any kind of structure or constraint, in any configuration known in the art.

In an alternate embodiment of FIG. 2, the roller 241 can be an idler (i.e. an undriven roller). For example, instead of being rotated by the machine 200, the support shafts 281 can be fixed in position, by rigid attachment to one or more other structures; that is, the support shafts 281 can be constrained for all degrees of freedom. In this alternate embodiment, the web 220 moves 228 and the roller 241 rotates 248 forward around the axis 246. The roller 241 rotates 248 at a particular angular velocity and the support shafts 281 have an angular velocity of zero. Since there is a difference between these angular velocities, the inner contact surface of each rotating bearing 263 rotates backward with respect to the outer contact surface of its roller bearing 261. As a result, rotational drag forces attempt to resist the relative backward rotation of the inner contact surfaces of the rotating bearings 263. Since the roller bearings 261 are connected to the roller 241, the outer contact surface of each roller bearing 261 does not rotate with respect to the roller 241.

Each of these real world structures in FIG. 2 is subject to real world constraints. While the web 220 can move along the web path 226, the web 220 is constrained to follow the web path 226. As the web 220 contacts the roller 241, there is friction between the web 220 and the roll face 242 of the roller 241. This friction constrains the movement of the web 220 along the web path 226. This friction also constrains the movement of the web 220 and the roller 241 with respect to each other. Since the support shafts 281 can rotate around the axis 246 but are otherwise fixed in position, each of the support shafts 281 has one degree of freedom, which is rotation around the axis 246. Since the rotating bearings 263 are connected to the support shafts 281, each of the rotating bearings 263 also has one degree of freedom, which is rotation around the axis 246. Since each rotating bearing 263 can rotate within its roller bearing 261, each roller bearing 261 also has one degree of freedom, which is rotation around the axis 246. Since the roller bearings 261 are connected to the roller 241, the roller 241 also has one degree of freedom, which is rotation 248 around the axis 246. These constraints can be used to represent these real world structures with a computer based model of the structures, as described in connection with the embodiments of FIGS. 4A and 4B.

Each of these real world structures is also subject to real world forces, resulting in various reactions. As upstream equipment and downstream equipment pull on the web 220, the web 220 comes under tensions. The tensions strain the web 220 and the pulling moves 228 the web 220 along the web path 226.

As the tensioned web 220 contacts the roller 241, the roller 241 is stressed, strained, and deflected. As the roller 241 contacts the roller bearings 261, the roller bearings 261 are also stressed, strained, and deflected. As the roller bearings 261 contact the support shafts 281, the support shafts 281 are also stressed, strained, and deformed.

Further, as the moving web 220 contacts the roll face 242 of the roller 241, friction imparts a force on the roll face 242. This force, applied at the radius of the roller 241, creates a moment. That moment tends to cause the roller 241 to rotate around the axis 246. As the roller 241 rotates around the axis 246, the connections between the roller 241 and the roller bearings 261 also cause the roller bearings 261 to rotate around. As each roller bearing 261 rotates around, internal friction causes its inner contact surface to resist rotation with respect to its outer contact surface, so the inner contact surface of each rotating bearing 263 tends to follow the outer contact surface of its roller bearing 261. This internal friction can be caused by mechanical contact and/or by fluid resistance.

Still further, as the supports shafts 281 are driven to rotate around the axis 246, the connections between the support shafts 281 and the rotating bearings 263 cause the rotating bearings 263 to rotate around. As each rotating bearing 263 rotates around, internal friction causes the outer contact surface of the roller bearing 261 to resist rotation with respect to its inner contact surface, so the outer contact surface of each roller bearing 261 tends to follow the inner contact surface of its rotating bearing 263. As the roller bearings 261 rotate around, the connections between the roller bearings 261 and the roller 241 also cause the roller 241 to rotate around.

In the embodiment of FIG. 2, since the roller 241 and the support shafts 281 rotate at the same angular velocity, the relative moments between the inner and outer contact surfaces of the roller bearings 261 are less than or equal to the static rotational drag force values of the roller bearings 261, and the rotational drag forces from the roller bearings 261 are equal to the relative moments, so the roller bearings 261 do not transmit varying rotational drag forces to the machine 200 or to the web 220.

However, if the roller 241 and the support shafts 281 rotate at different angular velocities, then the relative moments between the inner and outer contact surfaces of the roller bearings 261 are greater than the static rotational drag force values of the roller bearings 261, and the rotational drag forces from the roller bearings 261 are less than the relative moments, so the roller bearings 261 can transmit varying rotational drag forces to the machine 200 and to the web 220, as described in connection with the embodiments of FIGS. 3A-3D. These rotational drag forces from the roller bearings 261 can affect the physical behaviors of the machine 200 and the web 220 of FIG. 2, as described in connection with FIG. 1. These effects are complicated by the fact that real world rotational drag forces can vary with certain rotational drag factors. This variation is described in connection with the embodiments of FIGS. 3A-3D.

The rotatable object of FIG. 2, including any variations and any alternate embodiments, can be represented by one or more computer based models as described in connection with the embodiments of FIGS. 4A and 4B. Each of these models can be used in computer based methods for simulating rotational drag forces experienced by the rotating object, as described herein.

The rotational drag force exerted on a rotating object can depend on one or more rotational drag factors. As used herein, the term rotational drag factor refers to a quantifiable real world condition experienced by a rotating object. A rotating object can experience a rotational drag factor directly (i.e. in or on the object itself) and/or indirectly (e.g. through something that affects the rotation of the object, such as equipment related to the object's rotation). A rotational drag factor can vary over time as the object rotates. For example, at a first point in time, an object may experience a particular rotational drag factor at a first value, and at a second point in time, an object may experience that particular rotational drag factor at a second value that differs from the first value.

As the rotational drag factor varies, it can cause the rotational drag force to vary. In various embodiments, a rotating object can simultaneously experience various combinations of multiple rotational drag factors, each at varying values, which can, in combination, cause the rotational drag force to vary.

There are several kinds of rotational drag factors. One kind of rotational drag factor is equipment condition. An equipment condition quantifies the condition of the equipment that is related to the object's rotation. Equipment conditions include the alignment of the equipment, the temperature of the equipment, the condition of the equipment (e.g. wear of components, contamination, etc.), the choice of lubricant used with the equipment, etc. Another kind of rotational drag factor is environmental condition. An environmental condition quantifies the condition of the environment around the rotating object. Environmental conditions include the temperature of the environment, the humidity of the environment, the pressure of the environment, one or more field variables (e.g. electro-magnetic field), etc. Yet another kind of rotational drag factor is a process condition. A process condition quantifies the condition of the process applied to the object and/or the equipment related to the object's rotation. Process conditions include the loading applied to the object, the angular velocity of the rotating object, other conditions designed into the process of using the rotating object, etc.

FIGS. 3A-3D illustrate exemplary graphs, which plot rotational drag forces versus rotational drag factors for rotating objects. In each of the graphs, the plot defines the relationship between the rotational drag factor and the rotational drag force for the object, for a range of values for the rotational drag factor. While this relationship is illustrated in two-dimensional graphical form in FIGS. 3A-3D, in various embodiments, the relationship may be expressed in one or more additional or alternate forms, such as multi-dimensional graphs, tables, algorithms, mathematical expressions, etc.

FIG. 3A is a graph 390-a of exemplary measured rotational drag force 392 versus a rotational drag factor for the rotating bearings 162 from the machine of FIG. 1. In FIG. 3A, the rotational drag factor is the angular velocity 391-a of the inner surfaces of the rotating bearings 162 with respect to their base mounts 164. Since the idler shafts 145 are connected to the inner contact surfaces of the rotating bearings 162, the inner contact surfaces and the shafts 145 rotate at the same particular angular velocity. So, the angular velocity 391-a of the inner surfaces can also be considered to be the angular velocity of the idler 140.

The plot 393-a on the graph 390-a indicates a functional relationship between the angular velocity 391-a and the rotational drag force 392 from the rotating bearing 162. That is, for each particular angular velocity 391-a, the rotating bearing experiences a particular rotational drag force 392. At an angular velocity 391-a of zero, the plot 393-a intersects 394-1-a the vertical axis for rotational drag force 392, at a significant non-zero static rotational drag force value 392-1-a. As the angular velocity 391-a increases, the rotational drag force 392 also increases, across the entire range of angular velocities 391-a. In the embodiment of FIG. 3A, the plot 393-a is linear and the slope of the plot 393 is a positive value.

Slope is calculated as rise over run. For example, consider the portion of the plot 393-a from first point 394-2 to second point 394-3. From first point 394-2 to second point 394-3, the change in rotational drag force 396-a (rise) is a positive value, measured upward in the vertical direction. From first point 394-2 to second point 394-3, the change in angular velocity 395-a (run) is also a positive value, measured to the right in the horizontal direction. For the portion of the plot 393-a from first point 394-2 to second point 394-3, the slope is the rise 396-a divided by the run 395-a. Since both measurements are positive, the slope is positive. Since the plot 393-a is linear, the slope is also constant. The graph 390-a is typical for many embodiments of rotating bearings.

A graph of rotational drag force versus angular velocity can be generated for a particular rotating bearing by measuring its rotational drag force at a number of different angular velocities, as will be understood by one of skill in the art. The results can be plotted on a graph similar to the graph of FIG. 3A. The resulting plot may be similar to or different from the plot 393-a on the graph 390-a of FIG. 3A.

FIG. 3B is another graph 390-b of exemplary measured rotational drag force 392 versus a rotational drag factor 391-b. The plot 393-b on the graph 390-b indicates a functional relationship between the rotational drag factor 391-b and the rotational drag force 392. At a rotational drag factor 391-b of zero, the plot 393-b intersects 394-1-b the vertical axis for rotational drag force 392, at a significant non-zero static rotational drag force value 392-1-b. As the rotational drag factor 391-b increases, the rotational drag force 392 first increases, then decreases across the range of the rotational drag factor 391-b. In the embodiment of FIG. 3B, the plot 393-b is non-linear.

FIG. 3C is another graph 390-c of exemplary measured rotational drag force 392 versus a rotational drag factor 391-c. The graph 390-c includes a number of exemplary data points 397-1 through 397-5, each of which represents a particular rotational drag force measured at a particular value for the rotational drag factor 391-c. The graph 390-c also includes a plot 398, which is a linear fit based on the data points 397-1 through 397-5. The fitted plot 398 on the graph 390-c indicates a functional relationship between the rotational drag factor 391-c and the rotational drag force 392. At a rotational drag factor 391-c of zero, the plot 398 intersects 394-1-c the vertical axis for rotational drag force 392, at a significant non-zero static rotational drag force value 392-1-c. As the rotational drag factor 391-c increases, the rotational drag force 392 also increases, across the entire range of the rotational drag factor 391-c. In the embodiment of FIG. 3C, the plot 398 is linear and the slope of the plot 398 is a positive value.

FIG. 3D is a graph 390-d of exemplary estimated rotational drag force 392 versus a rotational drag factor 391-d. The plot 393-d on the graph 390-d indicates a step function relationship between the rotational drag factor 391-d and the rotational drag force 392. That is, for each particular range of values for the rotational drag factor 391-d, the rotational drag force 392 is a particular constant value. At a rotational drag factor 391-d of zero, the plot 393-d intersects 394-1-d the vertical axis for rotational drag force 392, at a significant non-zero static rotational drag force value 392-1-d. As the rotational drag factor 391-d increases, the steps 399-1 through 399-4 increase in value, across the entire range of the rotational drag factor 391-d. However, in various embodiments, the step function may take other forms, as will be understood by one of skill in the art.

A graph of rotational drag force versus one or more rotational drag factors can be generated for a particular rotating object and/or for equipment related to that object's rotation.

The graph can be generated by measuring rotational drag force at a number of values for the one or more rotational drag factors, as will be understood by one of skill in the art. The results can be plotted on a graph similar to the graphs of FIGS. 3A-3D.

The resulting plot may be similar to or different from the plots of these graphs. The plot may intersect the vertical axis at a relatively high rotational drag force value or a relatively low rotational drag force value. As the rotational drag factor(s) vary, the rotational drag force may increase, may stay constant, or may decrease over part, parts, or all of the range of values for the rotational drag factor(s). Part, parts, or all of the plot may be substantially or completely linear and/or part, parts, or all of the plot may be non-linear or curved. The plot may or may not indicate a functional relationship between the rotational drag factor(s) and rotational drag force. Part, parts, or all of the plot may be based on empirical data and/or part, parts, or all of the plot may be based on one or more mathematical functions, fitted to empirical data. The results can be based on measurements from a single sample or any number of samples.

A graph of rotational drag force versus one or more rotational drag factors can also be generated in other ways. For example, a plot can be determined by observing, analyzing, modeling, and/or estimating rotational drag forces. In various embodiments, a plot of rotational drag forces can differ from real world rotational drag forces, in order to simplify the representation of how rotational drag force varies with rotational drag factor(s), as will be understood by one of ordinary skill in the art.

Once a graph of rotational drag force versus one or more rotational drag factors is generated, the graph can be used to determine the rotational drag force for the object at one or more particular values of the one or more rotational drag factors. So, once it is understood how rotational drag force varies with one or more rotational drag factors, the rotational drag forces can be accurately represented in computer based models. This modeling is described in connection with the embodiments of FIGS. 4A-6.

FIGS. 4A and 4B illustrate computer based models. In a CAE operating environment, each part of a model may be visually displayed as various graphics or without a graphic. In FIGS. 4A and 4B, the parts of the models are depicted in an exemplary manner intended to illustrate their functionality and their interaction, as will be understood by one of skill in the art.

FIG. 4A is a diagram that illustrates a perspective view of a computer based model 401-a of a portion of the machine 100 and a portion of the web 120 of FIG. 1. The computer based model 401-a includes a web model 420, an idler model 440 and a first hinge connector 450. The computer based model 401-a also includes a first frame of reference 411, a second frame of reference 412, and a global frame of reference 410-g.

The computer based model 401-a can be created by using FEA software. The model 401-a, including the web model 420 and the idler model 440, can be created by putting in dimensions and material properties for the web 120 and the idler 140, generating a mesh, defining boundary conditions for the model 401-a, and defining interactions between the web model 420 and the idler model 440. By doing so, the computer based model 401-a can be configured to accurately simulate the rotational drag forces experienced by the idler 140 and the web 120.

Boundary conditions are defined variables that represent physical factors acting within a computer based model. Examples of boundary conditions include forces, pressures, velocities, displacements, and other physical factors. Each boundary condition can be assigned a particular magnitude, direction, location, and duration within the model. These values can be determined by observing, measuring, analyzing, and/or estimating real world physical factors. In various embodiments, computer based models can also include one or more boundary conditions that differ from real world physical factors, in order to account for inherent limitations in the models and/or to more accurately represent the overall physical behaviors of real world things, as will be understood by one of ordinary skill in the art. Boundary conditions can act on the model in various ways, to move, constrain, and/or deform one or more parts in the model.

The web model 420 represents the web 120, with elements in the model 420 corresponding with like-numbered elements of the web 120. Since the web model 420 represents the web 120, boundary conditions position, constrain, and move the web model 420 to represent the way that the web 120 is positioned, constrained, and moved. So, in the computer based model 401-a, the web model 420 contacts the idler model 440 and moves 428 along a model of a web path 426.

The idler model 440 represents the idler 140, with elements in the model 440 corresponding with like-numbered elements of the idler 140. The idler model 440 includes shafts 445 representing the shafts 145. In the embodiment of FIG. 4A, the shafts 445 extend farther than the shafts 145. The extended shafts 445 are not required in the model 401-a, but are included in FIG. 4A to illustrate the attachment of the first frame of reference 411 and interactions between the idler model 440 and the first hinge connector 450.

Since the idler model 440 represents the idler 140, boundary conditions position, constrain, and move the idler model 440 to represent the way that the idler 140 is positioned, constrained, and moved. The idler model 440 includes an axis of rotation 446 representing the axis 146, and the idler model 440 rotates 448 forward around the axis 446.

The first frame of reference 411 is a three-dimensional Cartesian coordinate system. The first frame of reference 411 includes coordinate axes, X₁, Y₁, and Z₁, which intersect at a common point and which are oriented orthogonally with respect to each other. However, in various embodiments, the first frame of reference 411 can be another kind of coordinate system.

The first frame of reference 411 is attached to the idler model 440. The first frame of reference 411 can be attached to the idler model 440 at various locations. In the embodiment of FIG. 4A, the Z₁ coordinate axis of the first frame of reference 411 is positioned to coincide with the axis of rotation 446. However, in various embodiments, the first frame of reference 411 can be attached to the idler model 440 in various alternate orientations. Since the first frame of reference 411 is attached to the idler model 440, and the idler model 440 is constrained to rotate around the axis 446, the first frame of reference 411 is also constrained to rotate around the axis 446. The first frame of reference 411 may be attached to the idler model 440 directly or indirectly through one or more alternate and/or additional parts of a computer based model, as will be understood by one of skill in the art.

The embodiment of FIG. 4A also includes a second shaft 465. The second shaft 465 is not a required part of the computer based model 401-a, but is included to illustrate the location of the second frame of reference 412 and interactions between the second frame of reference 412 and the first hinge connector 450. The second shaft 465 is a cylindrical shaft radially centered on the axis 446.

The first hinge connector 450, the second shaft 465, and the second frame of reference 412 of the model 401-a together represent rotational drag forces from the mounted bearings 160 of FIG. 1. Since the rotational drag forces from the mounted bearings 160 are transmitted through the idler 140 to the web 120, the first hinge connector 450, the second shaft 465, and the second frame of reference of the model 401-a together are also considered to represent rotational drag forces for the idler 140.

The first frame of reference 411 is connected to the first hinge connector 450. In the embodiment of FIG. 4A, the first frame of reference 411 is illustrated as connected to the first hinge connector 450 via an end of one of the shafts 445 of the idler model 440, but this form of connection is not required. The first frame of reference 411 may be connected to the first hinge connector 450 directly or indirectly through one or more alternate and/or additional parts of a computer based model, as will be understood by one of skill in the art.

The first hinge connector 450 is oriented along the axis 446. That is, the first hinge connector 450 is oriented such that its axis of rotation coincides with the axis 446. In FIG. 4A, the first hinge connector 450 is illustrated as a cylindrical sleeve that is radially centered on the axis 446. The first hinge connector 450 has a first end 451 and a second end 459.

At the first end 451, the first hinge connector 450 has a first opening 452. The first opening 452 is a cylindrical opening that is radially centered on the axis 446. The first opening 452 holds the end of one of the shafts 445 of the idler model 440. In various embodiments, the end of either of the shafts 445 can be used. The cylindrical inner wall of the first opening 452 is in contact with the outer roll face of the shaft 445 of the idler 440.

The second frame of reference 412 is also a three-dimensional Cartesian coordinate system. The second frame of reference 412 includes coordinate axes X₂, Y₂, and Z₂, which intersect at a common point and which are oriented orthogonally with respect to each other. However, in various embodiments, the second frame of reference 412 can be another kind of coordinate system.

The second frame of reference 412 is attached to the second shaft 465. The second frame of reference 412 can be attached to the second shaft 465 at various locations. In the embodiment of FIG. 4A, the Z₂ coordinate axis of the second frame of reference 412 is positioned to coincide with the axis of rotation 446. However, in various embodiments, the second frame of reference 412 can be attached to the second shaft 465 in various alternate orientations. The second frame of reference 412 may be attached to the second shaft 465 directly or indirectly through one or more alternate and/or additional parts of a computer based model, as will be understood by one of skill in the art.

At the second end 459, the first hinge connector 450 has a second opening 458. The second opening 458 is also a cylindrical opening that is radially centered on the axis 446. The second opening 458 holds one of the ends of the second shaft 465. The cylindrical inner wall of the second opening 458 is in contact with the outer roll face of the second shaft 465. Thus, the second shaft 465 is constrained to rotate around the axis 446. Since the second frame of reference 412 is attached to the second shaft 465, and the second shaft 465 is constrained to rotate around the axis 446, the second frame of reference 412 is also constrained to rotate around the axis 446.

The first hinge connector 450 is connected to the second frame of reference 412. In the embodiment of FIG. 4A, the first hinge connector 450 is illustrated as connected to the second frame of reference 412 via an end of the second shaft 465, but this form of connection is not required. The first hinge connector 450 may be connected to the second frame of reference 412 directly or indirectly through one or more alternate and/or additional parts of a computer based model.

Since the second frame of reference 412 is connected to the first hinge connector 450, and the first hinge connector 450 is connected to the first frame of reference 411, the second frame of reference 412 is connected to the first frame of reference 411 through the first hinge connector 450. And, since the first hinge connector 450 is oriented along the axis 446, the second frame of reference 412 is connected to the first frame of reference 411 along the axis 446.

The global frame of reference 410-g is also a three-dimensional Cartesian coordinate system. The global frame of reference 410-g includes coordinate axes X_{g}, Y_{g}, and Z_{g}, which intersect at a common point and which are oriented orthogonally with respect to each other. However, in various embodiments, the global frame of reference 410-g can be another kind of coordinate system.

In the embodiment of FIG. 4A, the first frame of reference 411 and the second frame of reference 412 are considered local frames of reference. The global frame of reference 410-g provides a coordinate system to account for movement of the first frame of reference 411 and the second frame of reference 412 within another physical context, such as a global space.

As the idler model 440 and the first frame of reference 411 rotate 448 around the axis 446 in a first angular direction, the idler model 440 and the first frame of reference 411 rotate with respect to the second shaft 465 and the second frame of reference 412. In the embodiment of FIG. 4A, the second shaft 465 and the second frame of reference 412 rotate 468 around the axis 446 in a second angular direction. However, in various embodiments the second shaft 465 and the second frame of reference 412 may not rotate around the axis 446, but may remain stationary. In the embodiment of FIG. 4A, the second shaft 465 and the second frame of reference 412 rotate 468 around the axis 446 in the second angular direction, wherein the second angular direction is opposite from the first angular direction. However, in various embodiments, the second shaft 465 and the second frame of reference 412 may rotate around the axis 446 in the same angular direction that the first frame of reference 411 rotates.

Since the second shaft 465 and the second frame of reference 412 are connected to the idler model 440 and the first frame of reference 411 through the first hinge connector 450, when the second frame of reference 412 rotates with respect to the idler model 440, program instructions can execute such that the second frame of reference 412 exerts a moment on the idler model 440 through the first hinge connector 450. Since the first hinge connector 450 is oriented along the axis 446, and the moment is exerted through the first hinge connector 450 program instructions can execute to direct the moment around the axis 446.

As the moment is exerted through the first hinge connector 450 program instructions can execute such that the moment can transform the computer based model 401-a. In particular, the moment transforms the idler model 440, by modeling the physical behavior of the idler 140 as the idler 140 experiences rotational drag force. The moment is directed around the axis 446, just as rotational drag force is directed around the axis 146. The moment is directed opposite from the first angular direction that the idler model 440 rotates 448, just as the rotational drag force is directed opposite from the direction that the idler 140 rotates 148. Since the idler model 440 rotates 448 forward, the moment resists its forward rotation, just as the idler 140 rotates 148 forward and the rotational drag force resists its forward rotation. And, since a static rotational drag force value exists as the idler 140 begins to rotate 148, the rotational drag force for the idler model 440 can be applied by exerting the moment before the idler model 440 and the first frame of reference 411 begin to rotate. So, the second frame of reference 412 rotating around the axis 446 with respect to the first frame of reference 411, represents the rotational drag force exerted on the idler 140. However, in various embodiments, the rotational force can be represented by additional and/or alternate model elements that can apply a force at a distance, which can resist the rotation of the idler, as will be understood by one of skill in the art.

The configuration of the first hinge connector 450 and the rotation of the second frame of reference 411, can be selected such that rotational drag force can be accurately represented in the computer based model 401-a.

In the computer based model 401-a of FIG. 4A, the first hinge connector 450 is equivalent to a hinge connector in ABAQUS FEA software, from SIMULIA. Program instructions for a hinge connector in ABAQUS can execute such that, each end of the hinge connector can separately rotate around an axis. In various embodiments, the first hinge connector 450 can be formed from one or more elements that function in a manner similar to the function of an ABAQUS hinge connector.

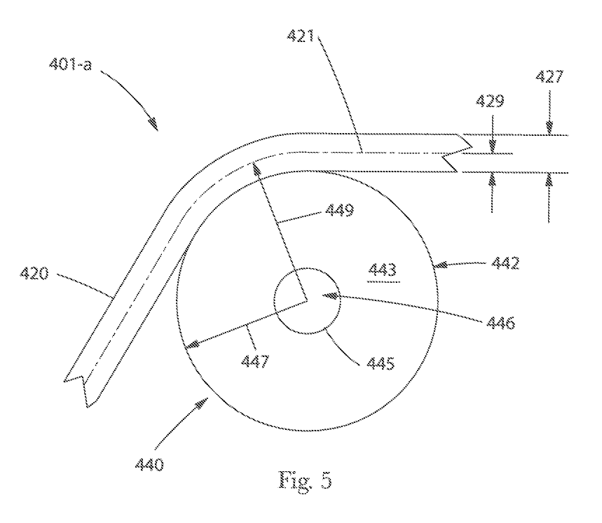

Program instructions for the first hinge connector 450 can execute such that the first hinge connector 450 exerts a moment on the idler model 440 with the moment having a magnitude that is based on two inputs. The first input is a constant predetermined damping factor, set by a user. For example, the constant predetermined damping factor can be determined as described in connection with the embodiment of FIG. 5. The second input is the difference in angular velocity from one end of the first hinge connector 450 to the other end of the hinge connector.

The difference in angular velocity from one end of the first hinge connector 450 to the other end of the first hinge connector 450 is the difference between: 1) the rotation 448 of the idler model 440 and the first frame of reference 411, and 2) the rotation 468 of the second shaft 465 and the second frame of reference 412. Program instructions can execute, using principles of physics and finite element analysis, to determine the rotation 448 of the idler model 440 and the first frame of reference 411. The rotation 468 of the second shaft 465 and the second frame of reference 412 can either be set by the user or determined by program instructions provided by the user.

In the real world, the magnitude of rotational drag force exerted on the idler 140 depends on the values of one or more rotational drag factors. These rotational drag factors and their values can be included in the computer based model 401-a, as will be understood by one of skill in the art. The relationship between these rotational drag factors and the rotational drag force can be determined as described in connection with the embodiments of FIG. 3A-3D. So, when the values for one or more rotational drag factors are known, and the relationship between the factors and rotational drag force is known, program instructions can execute to determine the rotational drag force to be exerted on the model of the idler 440 when the rotational drag factors are at those values.

When the rotational drag force to be exerted is known, the rotational drag force can be exerted by a moment from the first hinge connector 450, and the moment from the first hinge connector 450 can be set by inputs and/or program instructions from the user, the user can set the inputs and/or program instructions such that the first hinge connector 450 exerts an appropriate rotational drag force. In particular, the user can set the predetermined damping factor and can provide for a particular rotation 468 of the second shaft 465 and the second frame of reference 412, in order to generate a moment in the first hinge connector 450, such that the rotational drag force can be accurately represented in the computer based model 401-a, as described in connection with the embodiment of FIG. 5.

For example, the computer based model 401-a can be used to represent the idler 140 with the computer based model of the idler 440, wherein the idler 140 experiences a first rotational drag factor at a first value. A rotational drag force for the idler 140 can be represented with the first hinge connector 450, such that the computer based model of the idler 440 experiences the rotational drag force that corresponds with the first rotational drag factor at the first value. The second shaft 465 and the second frame of reference 412 can rotate 468 around the axis 446, at a particular angular velocity that is based on the first value of the first rotational drag factor. Thus, the computer based model of the idler 440 can be transformed, by modeling a physical behavior of the idler 140, as the idler 140 experiences the rotational drag force.

The computer based model 401-a of FIG. 4A can also be used to represent an alternate embodiment of FIG. 2, wherein the roller 241 is an idler and the support shafts 281 are fixed in position. In this representation, the computer based model 401-a can be used to represent the roller 241 with the computer based model of the idler 440, a rotational drag force for the idler 241 can be represented with the first hinge connector 450, and the computer based model of the idler 440 can be transformed, by modeling a physical behavior of the idler 241, as the idler 241 experiences the rotational drag force.

In various alternate embodiments of FIG. 4A, one or more additional and/or alternate parts, structures, functions, and/or boundary conditions can be included in the computer based model 401-a. While the embodiment of FIG. 4A describes and illustrates the first hinge connector 450 as connected to one of the shafts 445 of the idler 440, in various alternate embodiments, the computer based model 401-a can include any number of hinge connectors and shafts at various locations within the model.

For example, in addition to the first hinge connector 450, the model 401-a can include an additional hinge connector and shaft connected to the other shaft 445. As another example, the model 401-a can include two or more hinge connectors and shafts connected in series with the first hinge connector 450, as illustrated with the second hinge connector 470 in the embodiment of FIG. 4B. As a further example, the model 401-a can include two or more hinge connectors and shafts connected in parallel with the first hinge connector 450, that is, multiple hinge connectors and shafts that are connected across the same two nodes. Further, in various embodiments, the model 401-a can be further modified to any combination of any of these alternate embodiments.

In each embodiment of the model 401-a that includes two or more hinge connectors and shafts, the embodiment can be configured such that, the rotational drag force for the idler 140 can be represented by the combined effect of all of the hinge connectors. The combined effect can be distributed among the hinge connectors in any way. That is, each hinge connector can provide its own particular contribution to the combined effect of all hinge connectors. For example, the model 401-a can be configured with one or more hinge connectors and shafts in addition to the first hinge connector 450 and the second shaft 465, wherein each hinge connector contributes a portion of the rotational drag force that corresponds with a particular rotational drag factor.

FIG. 4B is a diagram that illustrates a perspective view of a computer based model 401-b of a portion of the machine 100 and of the web 120 of FIG. 1. The computer based model 401-b includes all of the parts of computer based model 401-a, configured as described in connection with the embodiment of FIG. 4A, except as otherwise described below. The computer based model 401-b also includes a second hinge connector 470, a third shaft 485, and a third frame of reference 413.

The embodiment of FIG. 4B also includes a third shaft 485. The third shaft 485 is not a required element in the computer based model 401-b, but is included to illustrate the location of the third frame of reference 413 and interactions between the third frame of reference 413 and the second hinge connector 470. The third shaft 485 is a cylindrical shaft radially centered on the axis 446.

The second hinge connector 470, the third shaft 485, and the third frame of reference 413 of the model 401-b together represent a convenient location for manipulating the location, orientation, and movement of the idler model 440, within the global frame of reference 410-g.

The second hinge connector 470 is oriented along the axis 446. That is, the second hinge connector 470 is oriented such that its axis of rotation coincides with the axis 446. In FIG. 4B, the second hinge connector 470 is illustrated as a cylindrical sleeve that is radially centered on the axis 446. The second hinge connector 470 has a first end 471 and a second end 479.

At the first end 471, the second hinge connector 470 has a first opening 472. The first opening 472 is a cylindrical opening that is radially centered on the axis 446. The first opening 472 holds the end of the second shaft 465. The cylindrical inner wall of the first opening 472 is in contact with the outer roll face of the second shaft 465.

The third frame of reference 413 is also a three-dimensional Cartesian coordinate system. The third frame of reference 413 includes coordinate axes X₃, Y₃, and Z₃, which intersect at a common point and which are oriented orthogonally with respect to each other. However, in various embodiments, the third frame of reference 413 can be another kind of coordinate system.

The third frame of reference 413 is attached to the third shaft 485. The third frame of reference 413 can be attached to the third shaft 485 at various locations. In the embodiment of FIG. 4B, the Z₃ coordinate axis of the third frame of reference 413 is positioned to coincide with the axis of rotation 446. However, in various embodiments, the third frame of reference 413 can be attached to the third shaft 485 in various alternate orientations. The third frame of reference 413 may be attached to the third shaft 485 directly or indirectly through one or more alternate and/or additional parts of a computer based model, as will be understood by one of skill in the art.

At the second end 479, the second hinge connector 470 has a second opening 478. The second opening 478 is also a cylindrical opening that is radially centered on the axis 446. The second opening 478 holds one of the ends of the third shaft 485. The cylindrical inner wall of the second opening 478 is in contact with the outer roll face of the third shaft 485. In the embodiment of FIG. 4B, the third shaft 485 and the third frame of reference 413 are fixed in place, constrained for all degrees of freedom. However, in various alternate embodiments, the third shaft 485 and the third frame of reference 413 can be constrained to rotate around the axis 446. And, in additional alternate embodiments, the third shaft 485 and the third frame of reference 413 can move within the global frame of reference 410-g.

The second hinge connector 470 is connected to the third frame of reference 413. In the embodiment of FIG. 4B, the second hinge connector 470 is illustrated as connected to the third frame of reference 413 via an end of the third shaft 485, but this form of connection is not required. The second hinge connector 470 may be connected to the third frame of reference 413 directly or indirectly through one or more alternate and/or additional parts of a computer based model.

Since the third frame of reference 413 is connected to the second hinge connector 470, and the second hinge connector 470 is connected to the second frame of reference 412, the third frame of reference 413 is connected to the second frame of reference 412 through the second hinge connector 470. And, since the second hinge connector 470 is oriented along the axis 446, the third frame of reference 413 is connected to the second frame of reference 412 along the axis 446.

In the embodiment of FIG. 4B, the third frame of reference 413 is considered a local frame of reference. The global frame of reference 410-g provides a coordinate system to account for movement of the first frame of reference 411, the second frame of reference 412, and the third frame of reference 413 within another physical context, such as a global space.

As the idler model 440 and the first frame of reference 411 rotate 448 around the axis 446 in a first angular direction, and the second shaft 465 and the second frame of reference 412 rotate 468 around the axis 446 in a second angular direction, the third shaft 485 and the third frame of reference 413 do not rotate around the axis 446, but remain stationary. However, in various embodiments, the third shaft 485 and the third frame of reference 413 may rotate around the axis 446.

The second hinge connector 470 does not exert a moment on the second shaft 465. The second hinge connector 470 can be configured in various ways, such that it does not exert a moment. For example, a constant predetermined damping factor for the second hinge connector 470 can be set to zero.

In the computer based model 401-b of FIG. 4B, the second hinge connector 470 is equivalent to a hinge connector in ABAQUS FEA software, from SIMULIA. However, in various embodiments, the second hinge connector 470 can be formed from one or more elements that function in a manner similar to the function of an ABAQUS hinge connector.

Since the second hinge connector 470 does not exert a moment on the second shaft 465, and since the third frame of reference 413 is connected to the second hinge connector 470, the third frame of reference 413 provides a convenient location for manipulating the location, orientation, and movement of the idler model 440, within the global frame of reference 410-g.

In various alternate embodiments of FIG. 4B, one or more additional and/or alternate parts, structures, functions, and/or boundary conditions can be included in the computer based model 401-b. As described in connection with the computer based model 401-a of FIG. 4A, in various alternate embodiments, the computer based model 401-b can be modified to include any number of hinge connectors and shafts, configured in series and/or in parallel, at various locations within the model. In each embodiment of the model 401-b that includes two or more hinge connectors and shafts, the embodiment can be configured such that, the rotational drag force for the idler 140 can be represented by the combined effect of all of the hinge connectors, distributed among the hinge connectors in any way, as described in connection with the computer based model 401-a of FIG. 4A.

In alternate embodiments, the second hinge connector 470 and the third shaft 485 can be connected to the parts of the model 401-b in some other way. For example, the second hinge connector 470 and the shaft 485 can be connected to either of the shafts 445. As another example, if the model 401-b includes two or more hinge connectors and shafts that contribute to the rotational drag force, as described in connection with embodiments of FIG. 4A, then the second hinge connector 470 and the third shaft 485 can be connected to any of those shafts.

FIG. 5 is a diagram that illustrates a side view of the geometry of a portion of the computer based model 401-a of FIG. 4A. FIG. 5 includes a portion of the web model 420 and the idler model 440, with elements in the model 440 corresponding with like-numbered elements of the idler 140. For clarity, the other parts of the computer based model 401-a are not shown in FIG. 5. Similarly, the embodiment of FIG. 5 can also represent the geometry of a portion of the computer based model 401-b of FIG. 4b.

The web model 420 has a uniform thickness 427 and a half thickness 429, which represent the thickness and half thickness of the web 120, respectively. The web model 420 also has a geometric centerline 421, which represents the half thickness of the web along its length. The idler model 440 has a roll face 442 that represents the roll face 142, a roll end 443 that represents the roll end 143, a shaft 445 that represents the shaft 145, and an axis 446 that represents the axis 146.

FIG. 5 illustrates a first dimensional radius 447, which represents the radial distance from the axis 146 to the outside surface of the roll face 142 of the idler 140. The first dimensional radius 447 is also the same as the radial distance from the axis 446 to the inside surface of the web 120.

FIG. 5 also illustrates a second dimensional radius 449 from the axis 446 to the stiffness centerline of the web model 420. The stiffness centerline of the web is the location in the web at which the bending moment is zero, when the web is conformed to a radius. In the embodiment of FIG. 5, the web 120 is modeled as having a uniform stiffness over its thickness, so the stiffness centerline of the web model 420 coincides with the geometric centerline 421 of the web model 420. Since the stiffness centerline of the web model 420 coincides with the geometric centerline 421, the second dimensional radius 449 is equal to the first dimensional radius 447 plus the half thickness 429. In various embodiments, a web may have a non-uniform thickness and/or non-uniform stiffness, wherein the position of the stiffness centerline of the web may or may not coincide with the geometric centerline of the web.

For the computer based model 401-a, the geometry of the web model 420, the geometry of the idler model 440, the static rotational drag force for the idler model 440, and the rotational drag force to be exerted on the idler model 440, all together can be used to configure the hinge connector 450 and the second frame of reference 412, such that rotational drag forces for the idler model 440 can be accurately represented in the model 401-a. The geometry of the web model 420 and the geometry of the idler model 440 can be determined from the real world web 120 and the real world idler 140, as described herein. The static rotational drag force for the idler model 440 and the rotational drag force to be exerted on the idler model 440 can be determined as described in connection with the embodiments of FIGS. 3A-3D.

The geometry of the web model 420 and the idler model 440, the static rotational drag force, and the rotational drag force to be exerted, all together, can be used to determine the damping factor for the first hinge connector 450, and the angular velocity of the rotation 468 of the second frame of reference 412. The damping factor is equal to the rotational drag force to be exerted, multiplied by the square of the second dimensional radius 449; that is:

DampingFactor=RotationalDragForcetobeExerted×SecondDimensionalRadius²

The angular velocity of the rotation of the second frame of reference 412 is equal to the static rotational drag force divided by the product of, the rotational drag force to be exerted and the second dimensional radius 449; that is:

$$AngularVelocity = \frac{StaticRotationalDragForce}{RotationalDragForcetobeExerted \times SecondDimensionalRadius}$$

Once the damping factor and the angular velocity are determined, the hinge connector 450 and the second frame of reference 412 can be configured to within the computer based model 401-a, such that rotational drag forces for the idler model 440 can be accurately represented.

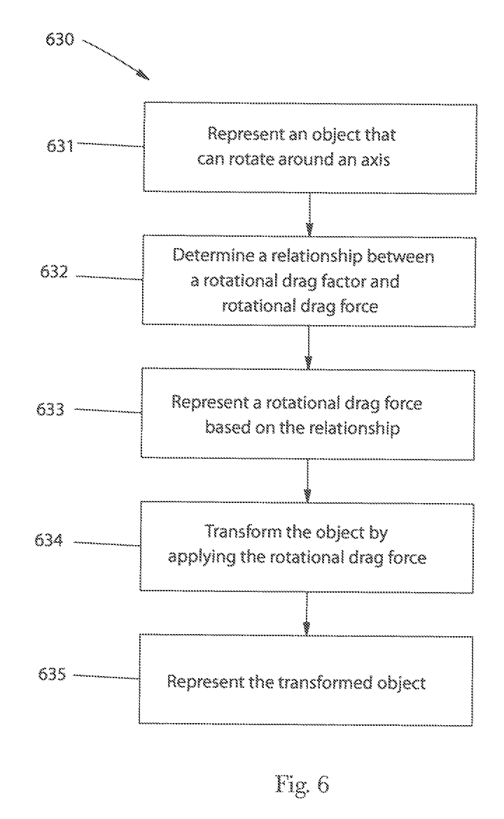

FIG. 6 is a flowchart that illustrates a method 630 for simulating with the computer based models of FIGS. 4A and 4B. Although the steps 631-635 of the method 630 are described in numerical order in the present disclosure, in various embodiments some or all of these steps can be performed in other orders, and/or at overlapping times, and/or at the same time, as will be understood by one of ordinary skill in the art.

The method 630 includes a first step 631 of representing an object that can rotate around an axis. A rotatable object can be represented with a computer based model of the object, just as the idler 140 of FIG. 1 and the roller 241 of FIG. 2 can be represented by the idler model 440 in the computer based models 401-a and 401-b of FIGS. 4A and 4B.

The method 630 includes a second step 632 of determining a relationship between a rotational drag factor for the object of the first step 631 and a rotational drag force for the object of the first step 631. The relationship can be determined for one or more values of one or more rotational drag factors, as described in connection with the embodiments of FIGS. 3A-3D.

The method 630 includes a third step 633 of representing a rotational drag force for the object of the first step 631, based on the relationship determined in the second step 632. For example, the rotational drag force can be represented with a second frame of reference 412 that rotates with respect to a first frame of reference 411, as described in connection with the embodiments of FIGS. 4A-4B.

The method 630 includes a fourth step 634 of transforming the object by applying the rotational drag force of the third step 633. The object can be transformed with program instructions that execute as described in connection with the embodiments of FIGS. 4A-4B.

The method 630 includes a fifth step 635 of representing the object of the first step 631, as transformed by the transformation of the fourth step 634. The transformed object results from the executed program instructions of the fourth step.

Thus, embodiments of the present disclosure can at least assist in predicting whether or not a machine can successfully be used to handle a web of material. The present disclosure includes methods of simulating the physical behavior of a web and one or more rollers as they interact within a machine. In particular, the present disclosure includes computer based methods for simulating rotational drag forces experienced by rollers. As a result, machines and webs can be evaluated and modified as computer based models before they are tested as real world things.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
representing an object with a computer based model of the object, wherein the model of the object is attached to a first frame of reference, and the object is constrained to rotate around an axis of rotation;
representing a rotational drag force for the object with a computer based model of the rotational drag force, wherein the model of the rotational drag force includes a second frame of reference that is connected to the first frame of reference along the axis of rotation, and the second frame of reference rotates around the axis of rotation with respect to the first frame of reference;
transforming the computer based model of the object by modeling a physical behavior of the object as the object experiences the rotational drag force, applying the rotational drag force to the object to form a transformed object; and
representing the transformed object with a computer based model of the transformed object.

2. The method of claim 1, wherein the representing of the object includes representing the object with a computer based model of the object wherein the first frame of reference is constrained to rotate around the axis of rotation.

3. The method of claim 1, wherein the representing of the object includes representing the object with a computer based model of the object wherein a coordinate axis of the first frame of reference coincides with the axis of rotation.

4. The method of claim 1, wherein the representing of the object includes representing the object with the computer based model of the object wherein the first frame of reference is connected to the second frame of reference by a hinge connector that is oriented along the axis of rotation.

5. The method of claim 1, wherein the representing of the object includes representing the object with the computer based model of the object wherein the first frame of reference is directly connected to the second frame of reference.

6. The method of claim 1, wherein the representing of the object includes representing the object with the computer based model of the object wherein the object is a roller.

7. The method of claim 6, wherein the representing of the object includes representing the object with the computer based model of the object wherein the object is an idler.

8. The method of claim 6, including representing a web with a computer based model of the web wherein the web is contacting the roller.

9. The method of claim 1, wherein:
the representing of the object includes representing the object with a computer based model of the object wherein the object and the first frame of reference rotate around the axis of rotation in a first angular direction; and
the representing of the rotational drag force includes representing the rotational drag force with a computer based model of the rotational drag force wherein the second frame of reference rotates around the axis of rotation in a second angular direction.

10. The method of claim 9, wherein the representing of the rotational drag force includes representing the rotational drag force with a computer based model of the rotational drag force wherein the second angular direction is opposite from the first angular direction.

11. The method of claim 9, wherein the transforming includes transforming the computer based model of the object by applying the rotational drag force to the object before the object and the first frame of reference begin to rotate around the axis of rotation in the first angular direction.

12. The method of claim 9, wherein:
the representing of the object includes representing the object with a computer based model of the object wherein the object experiences a first rotational drag factor at a first value; and
the representing of the rotational drag force includes representing the rotational drag force with a computer based model of the rotational drag force wherein the second frame of reference rotates around the axis of rotation in the second angular direction at a first particular angular velocity that is based on the first value of the first rotational drag factor.

13. The method of claim 12, wherein the representing of the object includes representing the object with a computer based model of the object wherein the first rotational drag factor is angular velocity.

14. The method of claim 12, wherein:
the representing of the object includes representing the object with a computer based model of the object wherein the object experiences the first rotational drag factor at a second value that differs from the first value; and
the representing of the rotational drag force includes representing the rotational drag force with a computer based model of the rotational drag force wherein the second frame of reference rotates around the axis of rotation in the second angular direction, at a second particular angular velocity that is based on the second value of the first rotational drag factor.

15. The method of claim 12, including:
determining a relationship between the first rotational drag factor and the rotational drag force for the object, for a range of values for the first rotational drag factor;
the representing of the object includes representing the object with a computer based model of the object wherein the object experiences the first rotational drag factor at varying values; and
the representing of the rotational drag force includes representing the rotational drag force with a computer based model of the rotational drag force wherein the second frame of reference rotates around the axis of rotation in the second angular direction, at particular angular velocities that are based on the relationship.

16. The method of claim 12, wherein:
the representing of the object includes representing the object with a computer based model of the object, wherein the object simultaneously experiences the first rotational drag factor at the first value and a second rotational drag factor at a second value; and
the representing of the rotational drag force includes representing the rotational drag force with a computer based model of the rotational drag force wherein the second frame of reference rotates around the axis of rotation in the second angular direction, at a third particular angular velocity that is based on both the first value of the first rotational drag factor and the second value of the second rotational drag factor.

17. The method of claim 1, wherein the representing of the rotational drag force includes representing the rotational drag force for the object with a computer based model of the rotational drag force wherein the second frame of reference is constrained to rotate around the axis of rotation.

18. The method of claim 1, wherein the representing of the rotational drag force includes representing the rotational drag force for the object with a computer based model of the rotational drag force wherein a coordinate axis of the second frame of reference coincides with the axis of rotation.

19. The method of claim 1, including representing an external constraint for the object with a computer based model of the external constraint, wherein the external constraint includes a third frame of reference that is connected to the second frame of reference by a hinge connector oriented along the axis of rotation.

20. The method of claim 19, wherein the representing of the external constraint, includes representing an external constraint wherein the third frame of reference is constrained for all degrees of freedom.

21. The method of claim 19, wherein the representing of the external constraint, includes representing an external constraint wherein a coordinate axis of the third frame of reference coincides with the axis of rotation.

22. A computer readable medium having instructions for causing a device to perform a method, the method comprising:
representing an object with a computer based model of the object, wherein the model of the object is attached to a first frame of reference, and the object is constrained to rotate around an axis of rotation;
representing a rotational drag force for the object with a computer based model of the rotational drag force, wherein the model of the rotational drag force includes a second frame of reference that is connected to the first frame of reference along the axis of rotation, and the second frame of reference rotates around the axis of rotation with respect to the first frame of reference;
transforming the computer based model of the object by modeling a physical behavior of the object as the object experiences the rotational drag force, applying the rotational drag force to the object to form a transformed object; and
representing the transformed object with a computer based model of the transformed object.

23. A method comprising:
representing an object with a computer based model of the object, wherein the object is constrained to rotate around an axis of rotation, and wherein the object experiences a first rotational drag factor at a first value;
representing a rotational drag force for the object with a computer based model of the rotational drag force, wherein the rotational drag force is based on the first value of the first rotational drag factor.
transforming the computer based model of the object, by modeling a physical behavior of the object as the object experiences the rotational drag force, applying the rotational drag force to the object to form a transformed object; and
representing the transformed object with a computer based model of the transformed object.

24. The method of claim 23, wherein the representing of the object includes representing the object with a computer based model of the object wherein the first rotational drag factor is an equipment condition.

25. The method of claim 24, wherein the representing of the object includes representing the object with a computer based model of the object wherein the equipment condition is selected from the group including:
alignment;
wear;
contamination; and
temperature.

26. The method of claim 23, wherein the representing of the object includes representing the object with a computer based model of the object wherein the first rotational drag factor is an environmental condition.

27. The method of claim 26, wherein the representing of the object includes representing the object with a computer based model of the object wherein the environmental condition is selected from the group including:
temperature;
humidity;
electro-magnetic field; and
atmospheric pressure.

28. The method of claim 23, wherein the representing of the object includes representing the object with a computer based model of the object wherein the first rotational drag factor is a process condition.

29. The method of claim 28, wherein the representing of the object includes representing the object with a computer based model of the object, wherein the process condition is loading.

30. The method of claim 28, wherein the representing of the object includes representing the object with a computer based model of the object, wherein the process condition is angular velocity.

31. The method of claim 23, wherein:
the representing of the object includes representing the object with a computer based model of the object wherein the object experiences the first rotational drag factor at a second value that differs from the first value; and
the representing of the rotational drag force includes representing the rotational drag force with a computer based model of the rotational drag force wherein the rotational drag force is based on the second value of the first rotational drag factor.

32. The method of claim 31 including:
determining the rotational drag force for the object at the first value of the first rotational drag factor; and
determining the rotational drag force for the object at the second value of the first rotational drag factor.

33. The method of claim 23 including:
determining a relationship between the first rotational drag factor and the rotational drag force for the object, for a range of values for the first rotational drag factor;
the representing of the object includes representing the object with a computer based model of the object, wherein the object experiences the first rotational drag factor at varying values; and
the representing of the rotational drag force includes representing the rotational drag force with a computer based model of the rotational drag force wherein the rotational drag force varies based on the relationship.

34. The method of claim 33 wherein the determining of the relationship includes determining a functional relationship between the first rotational drag factor and the rotational drag force for the object.

35. The method of claim 23, wherein:
the representing of the object includes representing the object with a computer based model of the object, wherein the object simultaneously experiences the first rotational drag factor at the first value and a second rotational drag factor at a second value; and
the representing of the rotational drag force includes representing the rotational drag force with a computer based model of the rotational drag force wherein the rotational drag force is based on both the first value of the first rotational drag factor and the second value of the second rotational factor.

36. The method of claim 23, wherein the transforming includes transforming the computer based model of the object by applying the rotational drag force to the object before the object and begins to rotate around the axis of rotation.

37. A computer readable medium having instructions for causing a device to perform a method, the method comprising:
representing an object with a computer based model of the object, wherein the object is constrained to rotate around an axis of rotation, and wherein the object experiences a first rotational drag factor at a first value;
representing a rotational drag force for the object with a computer based model of the rotational drag force, wherein the rotational drag force is based on the first value of the first rotational drag factor.
transforming the computer based model of the object, by modeling a physical behavior of the object as the object experiences the rotational drag force, applying the rotational drag force to the object to form a transformed object; and
representing the transformed object with a computer based model of the transformed object.
